(19) United States
(12) Patent Application Publication
(10) Pub. No.: US 2013/0327551 A1
(43) Pub. Date: Dec. 12, 2013

(54) DEVICE AND METHOD FOR ROCK AND - CONCRETE MACHINING

(71) Applicant: Lennart Donsé, Akersberga (SE)

(72) Inventor: Lennart Donsé, Akersberga (SE)

(21) Appl. No.: 13/261,718

(22) PCT Filed: Apr. 3, 2012
(86) PCT No.: PCT/SE2012/050366

§ 371 Date: Aug. 22, 2013

(30) Foreign Application Priority Data
Apr. 5, 2011 (SE) 1100249-0

(51) Int. Cl. B25D 9/12; B25D 9/04; B25D 9/14

(52) U.S. Cl. CPC B25D 9/125; B25D 9/14; B25D 9/04
USPC 173/1; 173/200; 251/63

(57) ABSTRACT

The invention concerns a hydraulic, valveless impact mechanism for use in equipment for the machining of at least one of rock and concrete comprising a machine housing (105; 205) with a cylinder bore, a piston (110; 210) mounted such that it moves within this bore arranged to carry out when in operation repetitive reciprocating motion relative to the machine housing and in this way to deliver impact directly or indirectly on a tool connectable to the equipment for machining at least one of rock and concrete, and where the piston includes a driving part (140; 240) that separates a first drive chamber (160; 260) and a second drive chamber (125; 225), with an effective volume that is greater than that of the first drive chamber. The impact mechanism comprises further a starting means arranged such that it creates for a short duration, during an initial pressurisation of the impact mechanism, a connection between the second drive chamber and the first drive chamber, where the said connection can remain during one complete stroke cycle, in order in this way to set the piston into self-oscillation and avoid the piston remaining stationary at an equilibrium position. Furthermore, the invention concerns a rock drill with such an impact mechanism, and a rock drill rig comprising such a rock drill, and further a hydraulic release valve for the start of valveless hydraulic impact mechanisms. The invention concerns in addition to this a starting method for a hydraulic valveless impact mechanism.

### TECHNICAL AREA

The present invention concerns hydraulic impact mechanisms of the type known as “slideless” or “valveless” to be used in equipment for machining at least one of rock and concrete, and equipment for drilling and breaking comprising such impact mechanisms, and a method for starting such impact mechanisms.

### BACKGROUND

Equipment for use in rock or concrete machining is available in variants with percussion, rotation, and percussion with simultaneous rotation. It is well-known that the impact mechanisms that are components of such equipment are driven hydraulically. A hammer piston, mounted to move within a cylinder bore in a machine housing, is then subject to alternating pressure such that a reciprocating motion is achieved for the hammer piston in the cylinder bore. The alternating pressure is most often obtained through a separate switch-over valve, normally of sliding type and controlled by the position of the hammer piston in the cylinder bore, alternately connecting at least one of two drive chambers, formed between the hammer piston and the cylinder bore, to a line in the machine housing with driving fluid, normally hydraulic fluid, under pressure, and to a drainage line for driving fluid in the machine housing. In this way a periodically alternating pressure arises that has a periodicity corresponding to the impact frequency of the impact mechanism.

It is also known, and has been for more than 30 years, to manufacture slideless hydraulic impact mechanisms, also known sometimes as “valveless” mechanisms. Instead of having a separate switch-over valve, the hammer pistons in valveless impact mechanisms perform also the work of the switch-over valve by opening and closing the supply and drainage of driving fluid under pressure during the motion of the piston in the cylinder bore in a manner that gives an alternating pressure according to the above description in at least one of two drive chambers separated by a driving part of the hammer piston. A precondition for thus to work is that channels, arranged in the machine housing for the pressurisation and drainage of a chamber, open out into the cylinder bore such that the openings are separated in such a manner that direct short-circuited connection between the supply channel and the drainage channel does not arise at any position during the reciprocating motion of the piston. The connection between the supply channel and the drainage channel is normally present only through a gap seal that is formed between the driving part and the cylinder bore. Otherwise, major losses would arise, since the driving fluid would be allowed to pass directly from the high-pressure pump to a tank, without any useful work being carried out.

In order for it to be possible for the piston to continue its motion from the time at which a channel for drainage of a drive chamber is closed until the time at which a channel for the pressurisation of the same drive chamber opens, or vice versa, it is required that the pressure in the drive chamber change slowly as a consequence of a change in volume. This may take place through the volume of at least one drive chamber being made large relative to what is normal for traditional impact mechanisms of sliding type.

It is necessary that the volume be large since the hydraulic fluid that is normally used has a low compressibility. We define the compressibility K as the ratio between the relative change in volume and the change in pressure: K=(dV/V)/dP. It is, however, more common to use the modulus of compressibility, p, as a measure of compressibility. This is the inverse of the compressibility as defined above, i.e. β=dP/(dV/V). The units of the modulus of compressibility are Pascal. The definitions given above will be used throughout this document.

The volume must be sufficiently large that the pressure in the chamber, during the change in volume the chamber undergoes during the motion of the hammer piston towards the opening of the channel for the pressurisation of the chamber, is not sufficient to reverse the motion of the piston before the channel opens.

SU 1068591 A reveals a valveless hydraulic impact mechanism according to a principle with alternating pressure in the upper drive chamber and a constant pressure in the lower, i.e. the chamber that is closest to the connection of the tool. What is aspired to in SU 1068591 A is improved efficiency through the introduction of a non-linear accumulator system working directly against the chamber in which the pressure alternates. This is shown with two separate gas accumulators, where one of these has a high charging pressure and the other has a low charging pressure.

One general problem with valveless machines is that it is difficult to initiate self-oscillation of the piston. The hammer piston tends to adopt an equilibrium position when the system pressure is connected, rather than beginning self-oscillation. One traditional starting method is to exchange the pressure connector and the return connector to the impact mechanism manually, for a short period. No consistently reliable method is known, and machines of this type are often subjected to starting problems. These starting problems occur partly in a random manner, and partly is association with, for example, the exchange of the hydraulic pump and the subsequent change in conditions.

### Purpose of the Invention and its Most Important Distinguishing Features

One purpose of the present invention is to demonstrate a design of a valveless hydraulic impact mechanism that provides the opportunity to improve significantly the starting properties and to reduce the number of troublesome starting operations, and to demonstrate a starting device and a method for the starting of valveless hydraulic impact mechanisms, and further to demonstrate rock drilling equipment that comprises hydraulic impact mechanisms according to the invention. This is achieved according to the description given in the independent claims. Further advantageous embodiments are described in the non-independent claims.

Our investigations have shown that the problem during starting is probably due to the piston during the initial pressurisation of a hydraulic valveless impact mechanism being driven in a direction towards the second chamber until the pressure starts to build up in this chamber. The piston then changes direction and continues in motion until a return line opens into the second chamber. This chamber is then drained until a balance of pressure is achieved, and the piston remains stationary at an equilibrium position at the edge of the return line.

It has been shown that the starting reliability is dramatically increased if a connection between a first drive chamber, which is constantly connected to the system pressure or impact mechanism pressure during operation, and a second drive chamber, which has an alternating pressure during operation, is established for a short time during the initial start-up, i.e. when the machine is being pressurised. It appears that such a short-duration connection of the two chambers creates an imbalance between the pressures in the chambers, and thus an imbalance on the forces that act on the piston. The piston is set into self-oscillation in this way. This self-oscillation continues with limited amplitude as long as the connection is held, but reaches full amplitude after the connection has been closed.

It is further advantageous if this connection is first established after at least one of the following events has occurred: the pressure in the first chamber exceeds the balance pressure; the pressure in the first chamber exceeds 60%, or alternatively 70%, of the full system pressure; the pressure in the first chamber exceeds 150 bar; the time required for the piston to achieve the equilibrium position after the start of the initial pressurisation has been reached; 0.4 seconds has passed since the start of the initial pressurisation; the piston has been detected to be in its equilibrium position.

When the starting means opens the connection between the two chambers, a reduction in the impact mechanism pressure that has so far been established occurs, since the second chamber, which is not yet connected, is to be filled with hydraulic fluid under pressure.

It is a further advantage if the connection remains open until this temporary reduction of the impact mechanism pressure has ended. This may take place through measurement of pressure or through control of duration. It has proved to be the case for control of duration that duration of at least 0.2 seconds is suitable. Duration in the interval 0.3-1.0 seconds, however, is to be preferred.

One means of achieving this may be a start valve in the form of a hydraulic release valve that opens with an automatic delay when it is supplied with driving fluid that has an increasing pressure, and subsequently closes automatically after a time delay.

Such a valve can be constructed with a return spring with an adjustable spring tension that acts on the valve piston in order to define the opening pressure of the valve, and with a number of restrictions or alternatively a variable restriction, in order to regulate the opening time of the valve. Such a valve will be described in detail below in connection with the drawings.

### BRIEF DESCRIPTION OF DRAWINGS

FIG. 1 shows a sketch of the principle of a valveless hydraulic impact mechanism with constant pressure under the piston, i.e. on that side that is facing a tool that can be connected, and with alternating pressure on the upper surface of the piston.

FIG. 2 shows a sketch of the principle, as in FIG. 1, with a starting means designed in a channel between the upper and the lower drive chambers.

FIG. 3 shows an embodiment of the invention in cross section. The principal part of a valveless hydraulic impact mechanism is shown to the left and the starting means in the form of a release valve to the right, also showing with dashed lines how hydraulic fluid under pressure is supplied.

FIG. 4 shows an embodiment of a restriction, known as an “edge restriction”.

FIG. 5 shows an embodiment of the starting means according to the invention in the form of a release valve.

FIG. 5a shows the valve in its closed condition, before the connected pressure has reached the preset level for the opening of the valve.

FIG. 5b shows the valve in its pulsed condition, i.e. when it opens for a short duration in order to allow hydraulic fluid under pressure to pass through it.

FIG. 5c shows the valve in its closed condition, after the starting procedure itself has completed. This condition is maintained, once it has been achieved, as long as the valve is held under pressure.

### DETAILED DESCRIPTION OF PREFERRED EMBODIMENTS

A number of designs of the invention will be described as examples below, with reference to the attached drawings. The protective scope is not to be regarded as limited to these embodiments; instead it is defined by the independent claims. Advantageous embodiments are described in the non-independent claims.

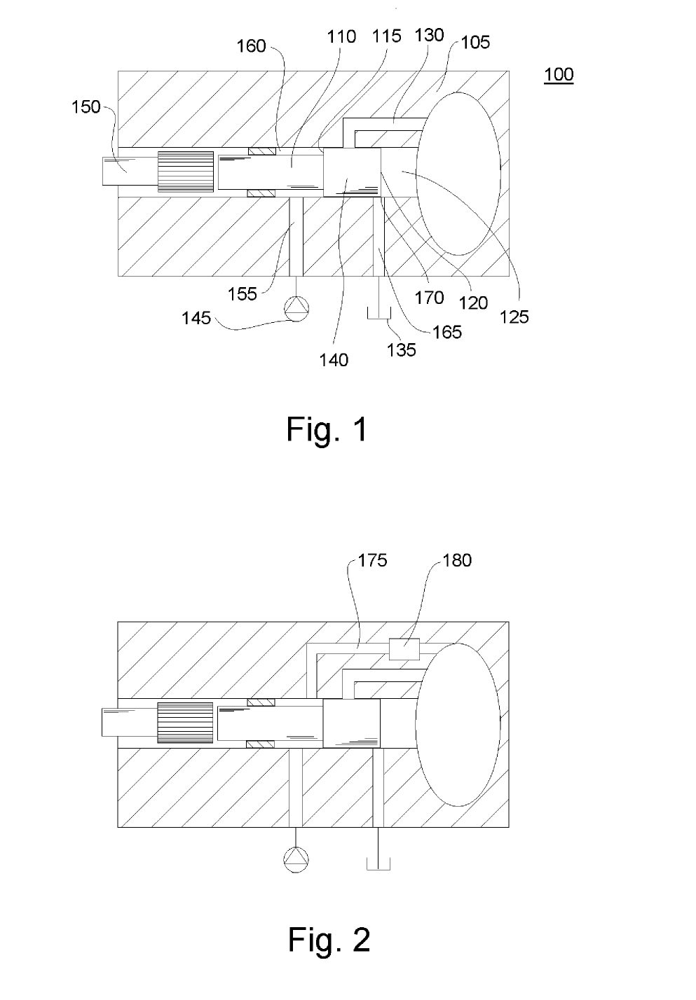

The principle of a hydraulic valveless impact mechanism, also known as a “slideless” mechanism, is illustrated in FIG. 1. A cylinder bore is arranged in a machine housing 105, in which bore a hammer piston 110 is mounted such that it is axially movable within this bore. The hammer piston includes two drive surfaces 115, 120 separated by a driving part 140 that has a larger diameter than neighbouring parts of the hammer piston. The drive surfaces are subject to a force, when fluid under pressure has been connected to the impact mechanism, corresponding to the pressure in the fluid multiplied by the area of the drive surface. The force acting on the drive surface 115 tends to drive the hammer piston 110 to the right, and the force on the drive surface 120 drives the hammer piston to the left and towards the tool that can be connected for the machining of rock or concrete. The hammer piston impacts onto a shank adapter 150, which in turn impacts onto the tool (not shown). The shank adapter comprises also splines or cogs for interaction with a rotation unit (not shown) in order that consecutive impacts against the rock or concrete should not impact on the same point. In its equilibrium condition, with fluid under pressure connected to the pressure line 155, and the return line 165 connected to a source of low-pressure or directly to a hydraulic tank 135, it is the intention that the hammer piston is to carry out a reciprocating motion in the cylinder bore and thus, once per cycle, to impact onto the tool through the shank adapter 150. The driving part of the hammer piston will, during this reciprocating motion, open and close a connection channel 130 between a first small drive chamber 160 and a second larger drive chamber 125. The driving part 140 will, in the same manner, open and close the connection of the return channel 165 with the second drive chamber 125. The second drive chamber has, together with a working volume that is continuously connected to it (shown as an ellipse in FIG. 1 and FIG. 2), an effective volume that is considerably larger than that of the first chamber. The working volume may be designed and connected to the second drive chamber in a number of different ways, in addition to that which is shown in FIGS. 1 and 2. The working volume may be designed, for example, as a cavity in the machine housing that is concentrically situated around the cylinder bore. What is important is that it is continuously connected to the second drive chamber, i.e. without interruption during a complete stroke cycle.

In order for the hammer piston 110 to move sufficiently far into a drive chamber 125 with alternating pressure, with the aid of its kinetic energy, after the driving part 140 has closed the connection to the return channel 165, such that a connection between the supply channel 130 and the chamber 125 can be opened, it is necessary that the chamber have a sufficiently large volume that the increase in pressure in the chamber as a consequence of the compression by the piston of the volume of oil that has now been enclosed within the chamber is not so large that the piston reverses its direction before a supply channel 130 has been opened into the chamber, such that the pressure can now rise to the full impact mechanism pressure, and the piston in this way be driven in the opposite direction. The drive chamber for this purpose is connected to a working volume (shown as an ellipse). Since this connection between the drive chamber and the working volume is maintained throughout the stroke cycle, we will denote the sum of the volume of the drive chamber and the working volume as the “effective drive chamber volume”.

A functioning design involves an effective drive chamber volume of 3 litres for a system pressure of 250 bar, impact energy of 200 Joules, a hammer piston weight of 5 kg, an area of the first drive surface 115 of 6.4 cm² and an area of the second drive surface 120 of 16.5 cm². The length of the driving part 70 mm and the distance of 45 mm between the supply channel 130 and the return channel 165 for the second drive chamber 125 at their relevant connections to the cylinder bore.

In addition to this type of valveless impact mechanism with a constant pressure on one side of the piston and an alternating pressure on the other side, variants are also available with alternating pressure on both sides of the hammer piston.

A common problem with these types of impact mechanism is that the starting procedure is unreliable. When the pressure is connected or when it starts to accumulate, initially in 155, the piston moves to the right. The piston first closes the return line 165 and subsequently opens the connection 130 from the first drive chamber to the second. The pressure in the second drive chamber 125 thus rises until the piston reverses its motion. The return connection 165 then opens again at this time and the pressure in the second chamber falls. As a consequence of this, the piston again will reverse its motion, and move to the right. The problem seems to be that the starting procedure fails through the piston becoming stationary, immediately or after a few cycles, in the position shown in FIG. 1 with the second drive surface 120 balancing at the edge of the return line 165, and through a balance pressure being maintained in the second drive chamber 125. This means that equal forces act on the piston in the two directions through the two drive surfaces 115, 120.

FIG. 2 shows how a connection that can be opened has been established between the two drive chambers 160, 125. This connection does not depend on the position of the piston in the cylinder bore, being instead only dependent on the status of a starting means 180.

It is significant that the starting means 180 establish connection during the initial pressurisation of the impact mechanism and that the starting means is placed in such a condition that the connection can remain without interruption during a complete stroke cycle.

It is advantageous that the starting means functions autonomously during the initial pressurisation, controlled only by the pressure that is connected to the impact mechanism.

It is advantageous also that the starting means opens the connection between the chambers only when the pressure at the first chamber 160 exceeds the balance pressure, i.e. the pressure in the second chamber 125 at which the forces on the piston from the drive surfaces that are placed under pressure are equal in the two directions.

It may be advantageous also that the starting means in arranged to open the connection between the drive chamber only when the pressure at the first drive chamber exceeds 60% of the full impact mechanism pressure. The impact mechanism pressure is normally the same as the system pressure.

Equipment to measure pressure may be mounted in the first chamber 160 or in the first channel 155 to determine these pressure-related opening criteria, and the opening initiated depending on a signal from this equipment to measure pressure. The signal may be either a fluid signal or an electrical signal. The starting means 180 is then either a pressure-controlled valve or an electrically controlled valve.

It may be advantageous, as an alternative, that the opening of the starting means also be dependent on the time that has passed since the pressurisation of the impact mechanism was initiated.

A further alternative for the opening of the starting means may be that it depends on the position of the hammer piston 110 in the cylinder bore. This requires means to measure position to be arranged for the position of the piston in the cylinder bore.

It is advantageous that the opening of the starting means has taken place before the pressure in the first drive chamber, or in the channel that supplies it, has reached the full impact mechanism pressure or system pressure.

It is further advantageous that the connection between the chambers is held open until the pressure has reached the same level as it had before the opening of the connection. The equipment to measure pressure can be used for this.

It may be advantageous also that the connection is held open for at least 0.2 seconds, preferably for duration in the interval 0.3-1.0 seconds.

It is in particularly advantageous that the starting means comprise a hydraulic release valve.

A hydraulic release valve 380 should comprise means for establishing a short-duration connection between an inlet port 383 and an outlet port 384, solely during the initial pressurisation of the valve.

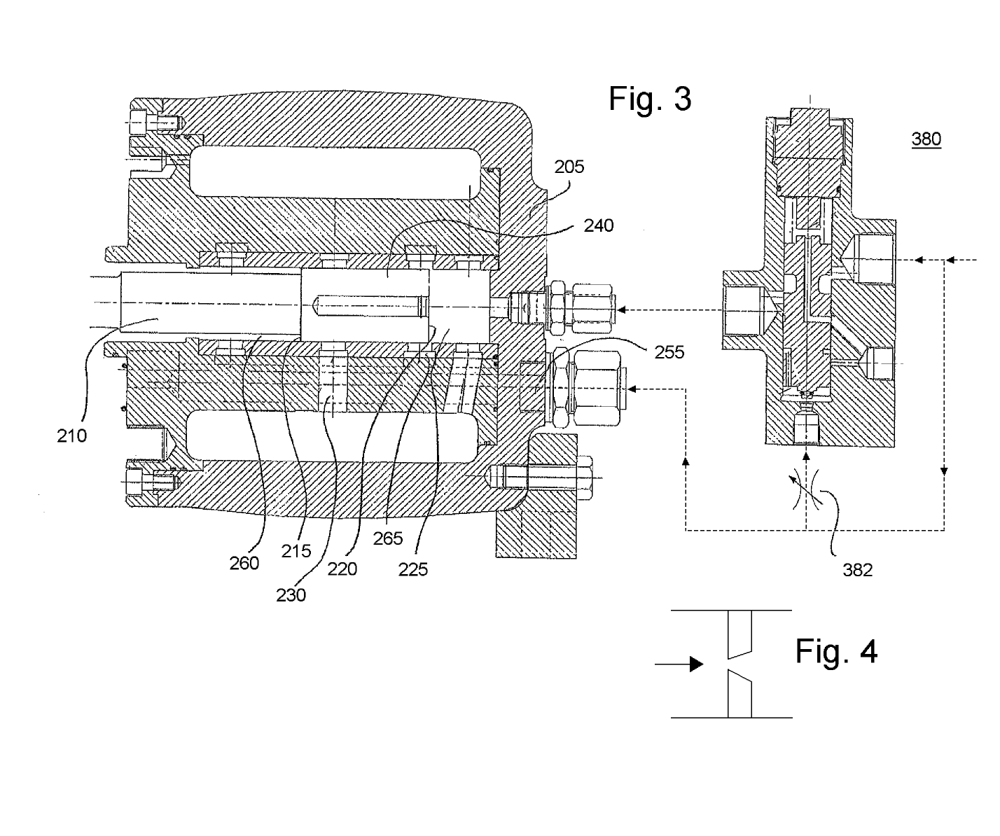

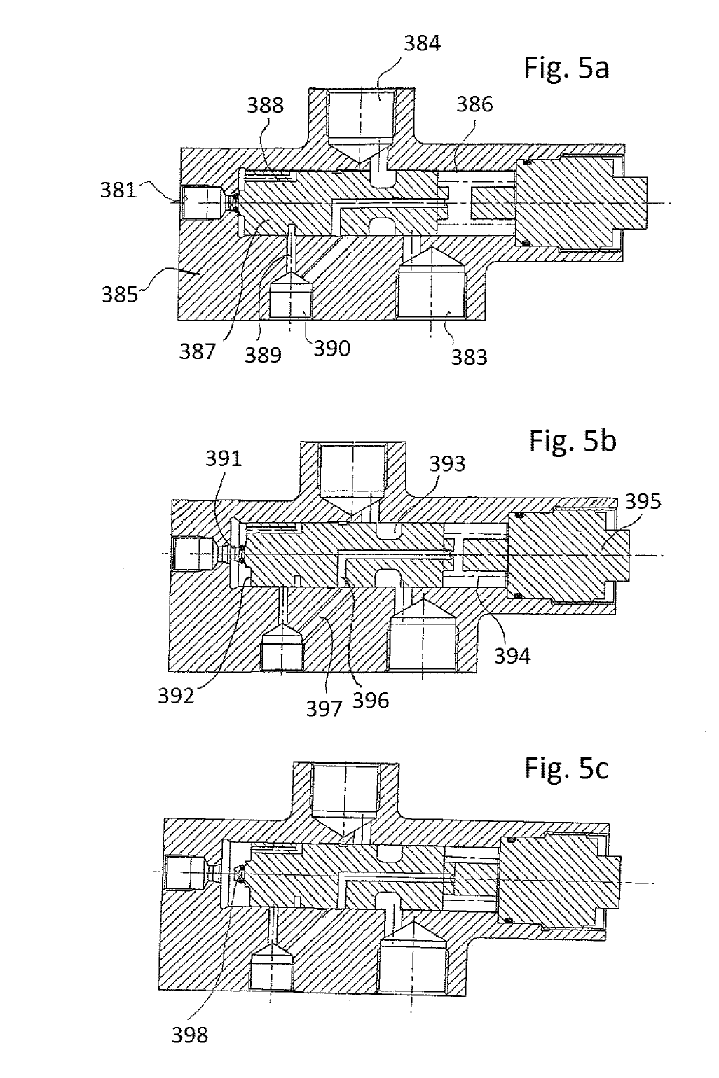

Hydraulic fluid under pressure arrives at the control port 381 through one or several restrictions 382. The restrictions serve the purpose of providing a limited flow to the control port and thus influencing the speed of the piston 387 of the release valve in its motion from a first end position as shown in FIG. 5a to the final second end position as shown in FIG. 5c. Such a restriction may be an edge restriction as shown in FIG. 4. It is appropriate that the opening be 0.5 mm in diameter. One or several such restrictions may be mounted in series in order to influence the length of the pulse from the release valve. It has not been necessary to use more than six in order to achieve the desired pulse length. An alternative is to have an adjustable restriction, as is indicated in FIG. 3.

When driving fluid under pressure reaches the control port 381 the driving fluid impacts on the first smaller drive surface 391 at the valve piston 387. The valve piston then moves to the right, and after a short distance the connection to the second larger drive surface 392 at the valve piston opens. The force now increases and the speed of the valve piston increases.

Through a ring-shaped track 393 in the circumference of the valve piston a connection is briefly opened between the inlet port 383 and the outlet port 384 as shown in FIG. 5b. This connection is closed when the valve piston continues towards its second end position as shown in FIG. 5c. The valve piston remains in this second end position as long as the impact mechanism is held under pressure. When the impact mechanism pressure is released, the valve piston is pressed back to its first end position by a return spring 394. The tension in the return spring may be adjusted by a spring tensioner 395 that is in threaded connection with the valve housing 385.

The transition between the first valve piston drive surface 391 and the second 392 is designed as a conical peg that forms a seal at its first end position with a conical seating in the valve housing 385. This peg may be provided with a track for an O-ring seal 398.

If the smaller end diameter of the peg is 7.5 mm, a suitable setting of the spring force is 630 N. It is in this way achieved that the valve first opens when sufficient impact mechanism pressure has been reached.

It is advantageous, in order to avoid enclosed amounts of fluid that would be able to influence the opening occasion negatively, that the compartment around the drive surfaces of the valve piston be drained before the valve piston regains its first end position as shown in FIG. 5a. For this purpose there is a drainage port 390, a second drainage channel 389 connecting the drainage port with the cylinder bore in the valve housing.

Furthermore, the valve piston itself is provided with a first drainage channel 388 that opens out into not only the first or second drive surface or in a cover surface that connects these drive surfaces, but also in the cover surface of the valve piston, preferably in the form of a ring-shaped track in this.

It is in a similar manner advantageous to arrange the drainage of the compartment on the other side of the valve piston, i.e. the side on which the return spring is active. This can take place through the drainage channels 396 and 397.

A hydraulic release valve can either be integrated completely into the machine housing 105; 205 of the impact mechanism or it may be designed as a separate unit that can be connected to the impact mechanism.

It is appropriate that an impact mechanism according to the invention is included in a rock drill. This may comprise, for example, a rotation unit in addition to the impact mechanism.

A rock drill according to the description above can be arranged on a rock drill rig in order to position and align the rock drill during the machining of rock or concrete.

An impact mechanism according to the invention may be integrated in the same manner in a hydraulic breaker, which in turn may be mounted on a rock drill rig or an excavator.

1. A hydraulic, valveless impact mechanism for use in equipment for machining at least one of rock and concrete comprising a machine housing with a cylinder bore, a movable piston mounted in this bore and arranged to carry out repetitively reciprocating motion during operation relative to the machine housing, and in this way to deliver impacts directly or indirectly against a tool connectable to the equipment for machining at least one of rock and concrete, and where the piston includes a driving part that separates a first drive chamber and a second drive chamber, with an effective volume that is larger than the volume of the first drive chamber, which said drive chamber is formed between the piston and the machine housing, and where these drive chambers are arranged such that they include during operation a hydraulic fluid under pressure, and where the machine housing further includes a first channel opening out into the cylinder bore and arranged such that it continuously supplies when in operation, during a complete stroke cycle, the first drive chamber with hydraulic fluid at an essentially constant pressure, such as the system pressure, and further a second channel arranged such that it connects in a cyclical manner, depending on the position of the piston in the cylinder bore, the second drive chamber with the return pressure, such as directly to a connectable hydraulic fluid tank, and further a third channel arranged such that it connects in a cyclical manner, depending on the position of the piston in the cylinder bore, the second drive chamber with the first drive chamber, where further the said third channel opens out into the cylinder bore between the respective openings into the cylinder bore of the first channel and the second channel, wherein the impact mechanism further comprises a starting means arranged to create for a short duration, during an initial pressurisation of the impact mechanism, a connection between the second drive chamber and the first drive chamber, where the said connection can remain during one complete stroke cycle, in order in this way to set the piston into self-oscillation and avoid the piston becoming stationary in an equilibrium position with a second drive surface at the edge of the second channel with hydraulic fluid of a balance pressure in the second drive chamber, where the said balance pressure amounts to the impact mechanism pressure multiplied by the ratio between a first driving area facing towards the first drive chamber and a second driving area facing towards the second drive chamber.

2. The hydraulic impact mechanism according to claim 1, where the said starting means acts autonomously during the initial pressurisation, controlled solely of the pressure that is connected to the impact mechanism.

3. The hydraulic impact mechanism according to claim 1, where the starting means is arranged to open the connection between the drive chambers only when the pressure at the first chamber exceeds at least the balance pressure.

4. The hydraulic impact mechanism according to claim 1, where the starting means is arranged to open the connection between the drive chambers only when the pressure at the first chamber exceeds 60% of the full system pressure.

5. The hydraulic impact mechanism according to claim 1, where the said starting means is arranged to open the connection between the drive chambers at the earliest after a period corresponding to the time required for the piston to achieve the equilibrium position, after the start of the initial pressurisation.

6. The hydraulic impact mechanism according to claim 1, where the starting means is arranged to open the connection between the drive chambers at the earliest 0.4 seconds after the start of the initial pressurisation.

7. The hydraulic impact mechanism according to claim 1, where the starting means is arranged to open the connection between the drive chambers only when the piston has been detected to be in its equilibrium position.

8. The hydraulic impact mechanism according to claim 1, where the starting means is arranged to open the connection before the pressure in the first drive chamber or the first channel has reached system pressure.

9. The hydraulic impact mechanism according to claim 1, where the starting means is arranged to maintain the connection between the drive chambers open until the impact mechanism pressure has reached the same level as it has immediately before the said connection was opened.

10. The hydraulic impact mechanism according to claim 1, where the starting means is arranged to maintain the connection between the drive chambers open for at least 0.2 seconds.

11. The hydraulic impact mechanism according to claim 1, where the starting means is constituted by a hydraulic release valve.

12. A hydraulic release valve for the start of a hydraulic, valveless impact mechanism, the said release valve comprising a valve housing with a valve cylinder bore, a valve piston mounted to move in the valve cylinder bore, arranged such that when in a non-pressurized state it takes up a first end position, and such that it moves from this first end position after a pressurisation operation to a second end position, wherein the valve piston comprises means to connect for a short duration an inlet port with an outlet port during motion of the valve piston from the first end position to the second.

13. The hydraulic release valve according to claim 12, comprising means to generate an adjustable counteracting force that acts on the valve piston in the direction towards the first end position.

14. The hydraulic release valve according to claim 12, where the valve piston comprises a first drive surface arranged such that, together with a hydraulic fluid under pressure that acts on the said first drive surface, it drives the valve piston, when the counteracting force has been overcome, towards the second end position, the said valve piston further comprising a second drive surface arranged to stand in connection with the said hydraulic fluid under pressure only after the motion towards the second end position has commenced.

15. The hydraulic release valve according to claim 14, where the valve piston further comprises a first drainage channel that opens out into not only either one of the first or second drive surfaces, or in a cover surface of a peg that connects these drive surfaces, but also the cover surface of the valve piston, the said first drainage being arranged such that it connects to a second drainage channel in the valve housing for a short duration during the motion of the piston.

16. The hydraulic impact mechanism according to claim 11, where the release valve comprises a valve housing with a valve cylinder bore, a valve piston mounted to move in the valve cylinder bore, arranged such that when in a non-pressurised state it takes up a first end position, and such that it moves from this first end position after a pressurisation operation to a second end position, wherein the valve piston comprises means to connect for a short duration an inlet port with an outlet port during motion of the valve piston from the first end position to the second.

17. The hydraulic impact mechanism according to claim 11, where the release valve has an opening time that is controlled by one or several throttle valves arranged to limit a flow of hydraulic fluid under pressure intended to open the said release valve.

18. A rock drill comprising the hydraulic impact mechanism according to claim 1.

19. A rock drill rig comprising the rock drill according to claim 18.

20. A method for the start of a hydraulic impact mechanism of valveless type, comprising the following steps:
the hydraulic impact mechanism is brought into contact with hydraulic fluid pressure
when the pressure in a first drive chamber in the hydraulic impact mechanism has been allowed to rise to at least 60% of the full system pressure, or when at least 0.4 seconds have passed since the pressurisation of the first drive chamber was started, a connection is opened for a short duration between the first drive chamber with a high pressure in the impact mechanism and a second drive chamber with a lower pressure
the said connection is maintained continuously open during at least one complete stroke cycle of the impact mechanism, and preferably for a period of at least 0.2 seconds.
